(19) United States
(12) Patent Application Publication
(10) Pub. No.: US 2009/0022994 A1
(43) Pub. Date: Jan. 22, 2009

(54) Composite Powder Products for Hardmetals

(76) Inventors: Hossein Aminian, St. Albert (CA); Ding Yuan, Edmonton (CA)

Correspondence Address: BRINKS, HOFER, GILSON & LIONE, 2801 SLATER ROAD, SUITE 120, MORRISVILLE, NC, 27560, US

(21) Appl. No.: 11/722,851

(22) PCT Filed: Nov. 29, 2005
(86) PCT No.: PCT/EP05/12884

§ 371 Date: Apr. 7, 2008

(30) Foreign Application Priority Data
Dec. 27, 2004 (EP) 04078532.1

(51) Int. Cl. B32B 15/02; C22C 32/00; B05D 7/00

(52) U.S. Cl. 428/404; 428/539.5; 427/217

(57) ABSTRACT

A composite powder product suitable for hardmetal cutting tools and wear resistance applications is described. The product comprises a hard particulate phase chosen from a range of metallic carbides, nitrides, carbonitrides and the like, onto which hard phase is deposited a coating of cobalt or nickel, or a mixture of cobalt and nickel. The hard particulate phase has a particle size between 0.1 and 10 μm, and preferably between 0.1 and 2 μm.

This invention relates to composite powder products suitable for hardmetal cutting tool and wear resistance applications. In particular, these products comprise a hard particulate phase chosen from a range of metallic carbides, nitrides, carbonitrides and the like, onto which a coating of cobalt or nickel, or a mixture of cobalt and nickel, is deposited. The hard particulate phase provides the cutting edge or the wear resistance, as applicable. The coated particles are formed into a solid part by conventional powder metallurgy techniques such as pressing and sintering. By this process, the coating becomes a relatively soft but tough continuous matrix supporting the hard particles.

Cobalt coated tungsten carbide particles (Co/WC) find use in hardmetals. Hardmetals are a class of materials that are used for cutting tools, metal forming and wear resistant applications. They are characterised by a hard phase, such as WC, and a relatively soft phase, such as Co. A hardmetal with a carbide phase is also known as a cemented carbide. A common method of making hardmetals is to extensively mill together the soft phase and the hard phase powders, to compact the mixture into near final shape, to sinter it at high temperature, and optionally to machine it to final shape. The soft phase acts as a binder for the hard phase particles, retaining them in the part matrix while they interact with a second body. An example would be a Co/WC drill used for forming a hole in steel.

For some hardmetals, nickel is preferred over cobalt as a binder because it bonds better to the hard particles; nickel is e.g. used as a binder for titanium and chromium carbides. Similarly, a nickel-cobalt mixture is a good binder for titanium carbonitride. Some hardmetals can be very complex and contain mixtures of tungsten, titanium, molybdenum and tantalum carbides and titanium carbonitrides. For these hardmetals, a nickel or nickel-cobalt binder may be more efficient than just pure cobalt, even though the hardmetals may have a tungsten carbide constituent.

It is important that each hard particle in the finished part is entirely surrounded by an adherent layer of the softer metal. One way to ensure this is to coat chemically instead of mechanically the hard particles with the softer metal. This obviates the risk of particle segregation, which tends to occur when disparate powders are milled together.

In U.S. Pat. No. 2,853,398, Mackiw et al disclose a pressure hydrogen reduction method of coating metals onto refractory oxide and sulphide core particles, making use of a nucleating agent. The intended application was high temperature materials, e.g. for jet engines. In U.S. Pat. No. 2,853,401 Mackiw et al. further disclose a method of coating metals, including Ni and Co, onto metal carbides, borides, silicides and nitrides. Intended applications include tools. The ‘hydrogen reduction method’, as described in U.S. Pat. No. 2,853,401 comprises the steps of reducing a metal from an ammoniacal metallic solution on a non-metallic particle by hydrogen gas in an autoclave, at a reduction temperature around 175° C. and a hydrogen partial pressure around 2.4 MPa. In U.S. Pat. No. 5,505,902, Fischer et al. describe a chemical solution method for coating an iron group metal onto a hard constituent comprising WC or other carbides. Examples show mixing of cobalt salts with WC followed by furnace reduction at 800° C. The examples show coatings of 6to 11% Co. In U.S. Pat. No. 5,529,804, Bonneau et al. disclose a method of deposition of metals, including Ni and Co, onto hard cores including WC, by the polyol process. The examples show coatings of 3, 6, 11% Co and 6% Ni. In WO 97/11805, Andersson et al, claim a method of coating Ni and/or Co by the polyol process onto hard constituent powder. US Publication 2003/0000340 A1 describes a method of spray-drying a metal solution such as Co with a dispersion of powders including WC, resulting in finely distributed Co in the WC matrix.

A technical paper entitled ‘New developments in the preparation of composite powders’ by Kunda, 7th Plansee Seminar, 1971, describes the pressure hydrogen reduction of Co onto a WC core. It mentions the need for core surface activation additives and notes that Co coating is more difficult than Ni, although carbides are relatively active cores. A technical paper entitled ‘A study of cobalt on Tungsten Carbide powder, using the hydrogen reduction method’ by Jung-Jae et al., J. Kor. Inst. Met & Mater, Vol 38, No. 5 (2000), describes the Co coating of a 2.39 μm particle size WC.

In the prior art, it was not possible to provide for homogeneously coated hard particulate phases having extremely low particle sizes. This problem is solved in the present invention, which discloses a composite powder product comprising a hard particulate phase coated by cobalt or nickel, or a mixture of cobalt and nickel, the hard particulate phase having a particle size between 0.1 and 10 μm, preferably between 0.1 and 6 μm. Particle sizes down to less than 2 μm or even 1 μm are even more preferred, because there is an increasing trend toward smaller dimensions in hardmetal parts. Examples are: precision micro-drills for making via holes in printed circuit boards having diameters of less than 0.5 mm; carbide balls in fine tip ball point pens; carbide edges on blades that are ground to razor sharpness. For these types of application, very fine carbides, frequently with a particle size of less than 1 μm, are needed to ensure a homogeneous wear or cutting surface on a microscopic scale.

The hard particulate phase can be chosen from a group comprising metal carbides, nitrides, carbonitrides and the like, wherein in one embodiment the metallic element can be tungsten, titanium, tantalum, molybdenum, niobium, vanadium, or chromium or a combination of two or more of these metals. The coating metal can be cobalt, nickel, or a mixture of both. In a preferred embodiment, the coating is cobalt and the hard particulate phase is tungsten carbide.

The composite powder is made by a process whereby the hard particles are introduced into a reaction pressure vessel containing a cobalt and/or nickel solution. Under hydrogen pressure and high temperature, the cobalt and/or nickel is induced to precipitate from solution onto the hard phase particles, so as to completely coat them. The coated particles are then washed and dried. This precipitation step was already referred to as the pressure hydrogen reduction process.

The invention teaches that surprisingly, using the pressure hydrogen reduction process, it is possible to coat a wide range of hard phase particle sizes not hitherto reported. Hydrogen reduction can preferably be performed at a partial hydrogen pressure of 2 to 5 MPa, at a temperatures of 120 to 200° C., from a solution containing preferably 10 to 60 g/L ammonium hydroxide. Particularly, the ability to coat very fine particles is enhanced by the post-reduction capabilities of the pressure hydrogen reduction process, e.g. filtration and drying. This is in contrast to what might be expected from other processes, such as those using polyols, where the high solution viscosity renders the economical coating of very fine WC particles difficult or impossible.

In the common art of making hardmetals, a mixture of hard particulate powder and metal matrix powder is pressed and sintered. This can lead to inhomogeneous final parts due to imperfect mixing. The present invention provides an improvement in that the metal matrix component and the hard phase are in intimate contact from the start, which ensures excellent homogeneity of the final structure. A hardmetal comprising a sintered composite powder product as described above is also an embodiment of the invention. Also the use of a hydrogen reduction method for obtaining a composite powder product as described above is part of the invention.

Another aspect of the invention is the coating homogeneity, which is important to ensure a defect-free hardmetal product. This homogeneity is enabled by the pressure hydrogen reduction process. This contrasts with a process where the hard phase is mixed with a salt of the coating metal and then reduced to metal in a furnace: it has to be expected that the coating metal forms discrete lumps on the hard particulate phase surface rather than a smooth continuous coating.

In one embodiment of the invention, the composite powder product comprising a hard particulate phase has a uniform and homogeneous coating, which represents between 2 and 20%, and preferably between 2 and 13% by weight of the composite powder.

In another embodiment, a process for preparing a composite powder product, comprising tungsten carbide, coated with a metal phase selected from cobalt, nickel or a nickel-cobalt alloy is claimed, comprising the steps of feeding tungsten carbide powder having a particle size of 0.1-10 μm, and preferably more narrow ranges as stated above, together with either one or both of a cobalt sulphate and a nickel sulphate solution, and ammonium hydroxide to an autoclave, precipitating the cobalt and/or nickel onto the tungsten carbide surface by reacting the cobalt and/or nickel ions with hydrogen, thereby obtaining a coated tungsten carbide slurry, and washing, filtering and drying said tungsten carbide slurry. In a preferred embodiment, at least 98% and preferably at least 99% by weight of the cobalt and/or nickel ions present in the sulphate solution is precipitated onto the tungsten carbide surface.

For the purpose of illustrating the invention, examples have been chosen where WC particles covering a range of sizes have been successfully coated with cobalt. The thickness of the coating is expressed as weight percent of deposited metal relative to the total weight of the coated product.

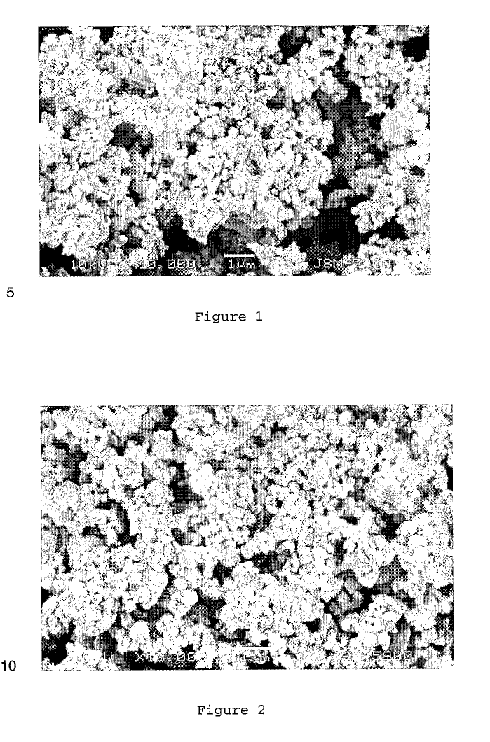

FIG. 1 shows a 0.79 μm WC core

FIG. 2 shows the WC particles of FIG. 1 coated with 8.22% of Co

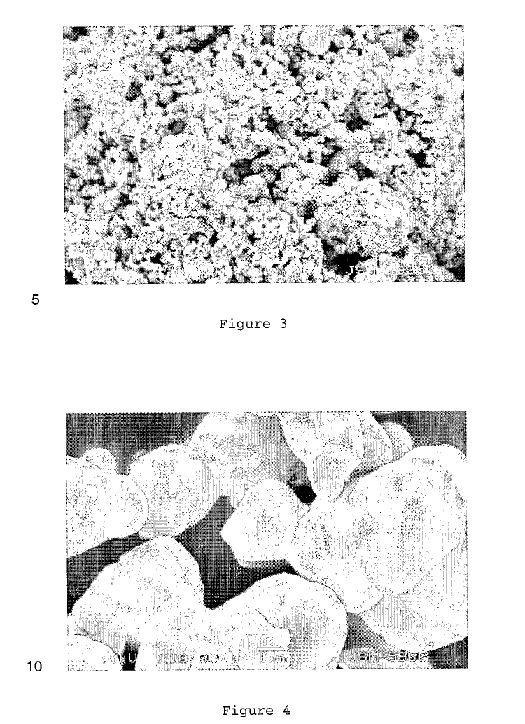

FIG. 3 shows 2.95% Co coated on 0.79 μm WC particles

FIG. 4 shows a 5.67 μm WC core

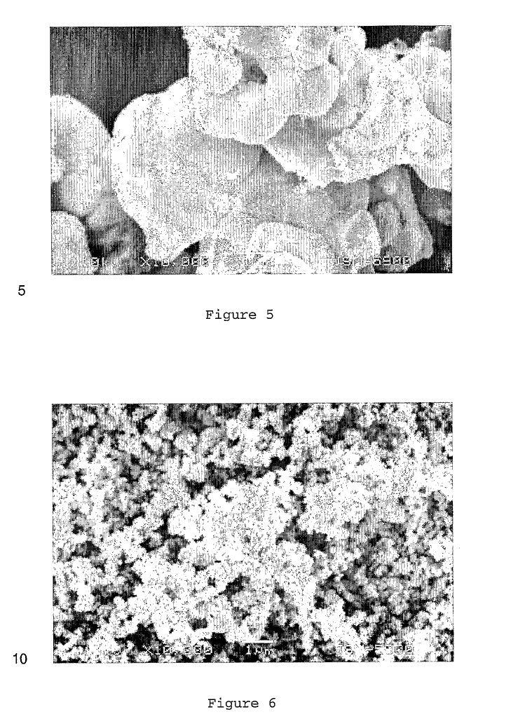

FIG. 5 shows the WC particles of FIG. 4 coated with 6.02% of Co

FIG. 6 shows a 0.52 μm WC core

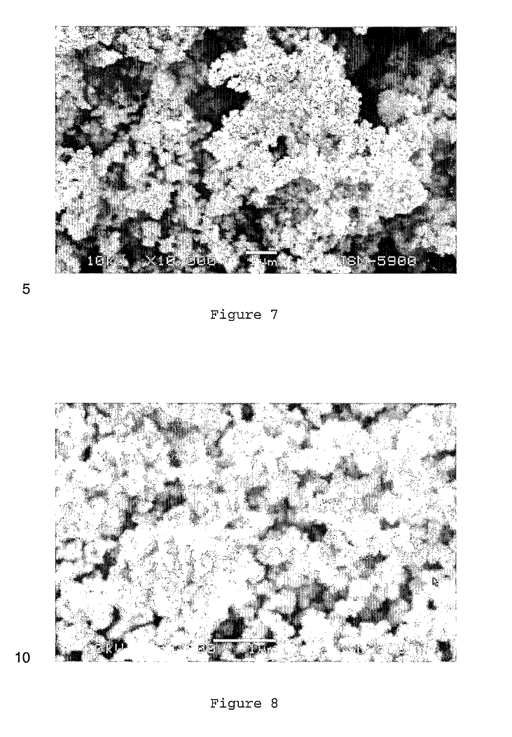

FIG. 7 shows the WC particles of FIG. 6 coated with 6.09% of Co

FIG. 8 shows a 0.13 μum WC core

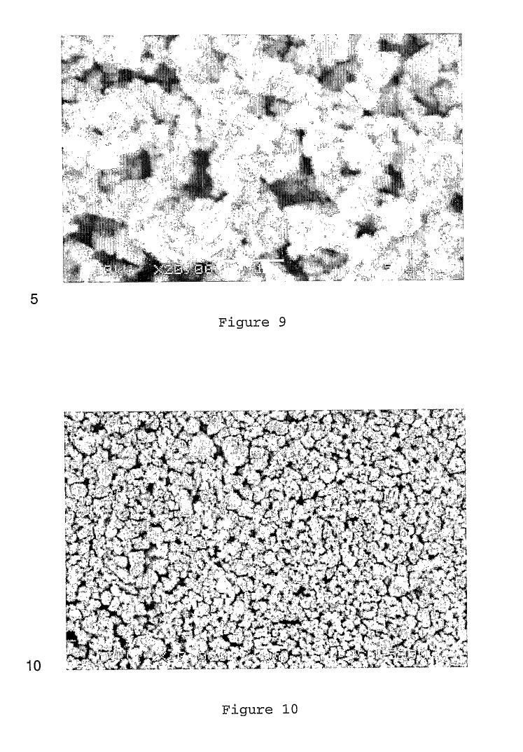

FIG. 9 shows the WC particles of FIG. 8 coated with 7.57% of Co

FIG. 10 shows a 0.59 μm WC core.

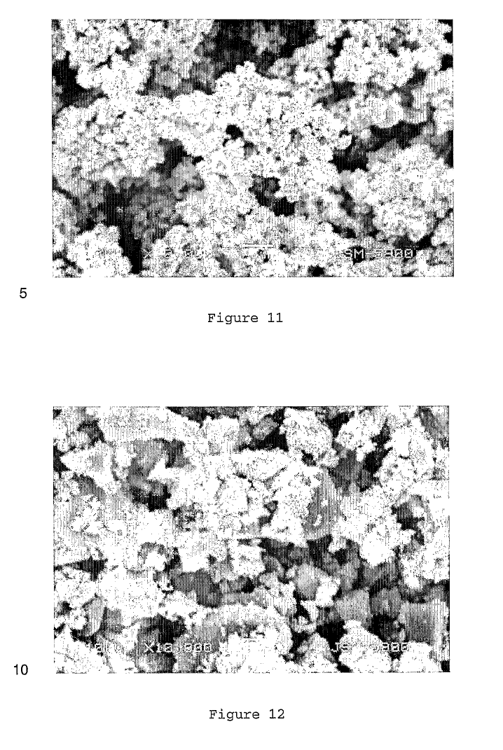

FIG. 11 shows the WC particles of FIG. 10 coated with 13.03% of Co

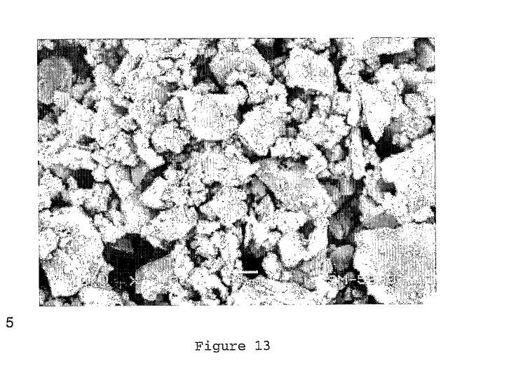

FIG. 12 shows a 0.84 μm TiC core.

FIG. 13 shows the TiC particles of FIG. 12 coated with 10.2% of Ni.

### EXAMPLE 1

A batch of 9692 g of WC powder having a particle size of 0.79 μm as measured by a Fisher Sub Sieve Sizer (Fisher number) was mixed in an autoclave with cobalt sulphate containing 879 g of Co in an ammoniated solution containing 288 g of NH₃. The foregoing were made up with water, to a volume of 17 L. The reduction temperature was 180° C. and the hydrogen partial pressure 3.45 MPa. After washing and drying, the cobalt deposit was 8.22%, which means that the coating efficiency was 98.9%. The coating appears smooth and continuous. FIG. 1 shows the WC core and FIG. 2 shows the cobalt-coated product.

### EXAMPLE 2

WC powder having a particle size of 0.79 μm (Fisher number) from the same batch as Example 1 was coated with cobalt using the pressure hydrogen reduction process. About 3550 g of WC was mixed with 110 g Co as CoSO₄ and with an ammoniated solution containing 108 g NH₃. The foregoing were made up with water, to a volume of 17 L. This mixture was processed at 180° C. and at a hydrogen pressure of 3.45 MPa. This resulted in 2.95% Co in the coated product, corresponding to 98.2% efficiency. FIG. 3 shows the cobalt-coated product. The coating appears smooth and continuous.

### EXAMPLE 3

WC powder having a particle size of 5.67 μm (Fisher number) was coated with cobalt using the pressure hydrogen reduction process. The conditions were similar to Example 1. The cobalt deposit was 6.02% of the coated product. FIG. 4 shows the WC core and FIG. 5 shows the cobalt-coated product.

### EXAMPLE 4

WC powder having a particle size of 0.52 μm (Fisher number) was coated with cobalt using the pressure hydrogen reduction process. The cobalt deposit was 6.09% of the coated product. FIG. 6 shows the WC core and FIG. 7 shows the cobalt-coated product.

### EXAMPLE 5

WC powder having a particle size of 0.13 μm was coated with cobalt using the hydrogen reduction process. Because a Fisher Number measurement is not considered reliable below 0.5 μm, a surface area technique was used to determine the WC particle size, using the formula: Particle Size=6/(Density×Specific Surface Area). FIG. 8 shows the WC core and FIG. 9 shows the coated product. The cobalt deposit amounted to 7.57% of the coated product.

### EXAMPLE 6

WC powder having a particle size of 0.59 μm (Fisher number) was coated with cobalt using the hydrogen reduction process. FIG. 10 shows the WC core and FIG. 11 shows the coated product. The cobalt deposit amounted to 13.03% of the coated product.

### EXAMPLE 7

TiC powder having a particle size of 0.84 μm (Fisher number) was coated with nickel using the hydrogen reduction process. About 800 g of TiC was mixed with 92.3 g Ni as NiSO₄, with an ammoniated solution containing 57 g NH₃ and with 380 g ammonium sulphate. The foregoing were made up with water, to a volume of 2.5 L. This mixture was processed at 150° C. and at a hydrogen pressure of 3.45 MPa. This resulted in 10.2% Ni in the coated product, corresponding to 98.3% efficiency. FIG. 12 shows the TiC core and FIG. 13 shows the nickel-coated product.

1-11. (canceled)

12. A composite powder product comprising a hard particulate phase coated with cobalt or nickel, or a mixture of cobalt and nickel, wherein the hard particulate phase has a particle size between 0.1 and 10 μm.

13. The composite powder product according to claim 12, wherein the hard particulate phase has a particle size between 0.1 and 6 μm.

14. The composite powder product according to claim 12, wherein the hard particulate phase has a particle size between 0.1 and 2 μm.

15. The composite powder product according to claim 12, wherein the hard particulate phase has a particle size between 0.1 and 1 μm.

16. The composite powder product according to claim 12, wherein the hard particulate phase is selected from the group consisting of metal carbides, nitrides, carbonitrides, and mixtures thereof.

17. The composite powder product according to claim 16, wherein the metallic element of the hard particulate phase is either one or more of tungsten, titanium, molybdenum, tantalum, niobium, vanadium, and chromium.

18. The composite powder product according to claim 16, wherein the hard particulate phase is a mixture of tungsten carbide and chromium carbide or vanadium carbide.

19. The composite powder product according to claim 16, wherein the hard particulate phase is a mixture of tungsten carbide and chromium carbide and vanadium carbide.

20. The composite powder product according to claim 12, wherein the coating is cobalt and the hard particulate phase is tungsten carbide.

21. The composite powder product according to claim 12, wherein the coating is uniform and homogeneous, and represents between 2 and 20% by weight of the composite powder.

22. The composite powder product according to claim 12, wherein the coating is uniform and homogeneous, and represents between 2 and 13% by weight of the composite powder.

23. A hardmetal comprising a sintered composite powder product, the composite powder product comprising a hard particulate phase coated with cobalt or nickel, or a mixture of cobalt and nickel, wherein the hard particulate phase has a particle size between 0.1 and 10 μm.

24. A tungsten carbide product coated with a metal phase selected from cobalt, nickel or a nickel-cobalt alloy, prepared by the method of:
feeding tungsten carbide powder having a particle size of 0.1-10 μL, together with either one or both of a cobalt sulphate and a nickel sulphate solution, and ammonium hydroxide, to an autoclave; and
precipitating the metal phase onto the tungsten carbide powder surface by reacting the cobalt and/or nickel ions with hydrogen, thereby obtaining a coated tungsten carbide slurry, and washing, filtering, and drying said tungsten carbide slurry.

25. A process for preparing a composite powder product comprising the steps of:
feeding tungsten carbide powder having a particle size of 0.1-8 μm, together with either one or both of a cobalt sulphate and a nickel sulphate solution, and ammonium hydroxide, to an autoclave; and
precipitating a metal phase onto the tungsten carbide powder surface by reacting the cobalt and/or nickel ions with hydrogen, thereby obtaining a coated tungsten carbide slurry, and washing, filtering, and drying said tungsten carbide slurry.

26. The process according to claim 25, wherein the metal phase is selected from cobalt, nickel, or a nickel-cobalt alloy.

27. The process according to claim 25, wherein the tungsten carbide powder has a particle size of 0.1-2 μm.

28. The process according to claim 25, wherein at least 98% by weight of the cobalt and/or nickel ions present in their sulphate solution is precipitated onto the tungsten carbid surface.

29. The process according to claim 25, wherein at least 99% by weight of the cobalt and/or nickel ions present in their sulphate solution is precipitated onto the tungsten carbide surface.
